(19) United States
(12) Patent Application Publication
(10) Pub. No.: US 2008/0141848 A1
(43) Pub. Date: Jun. 19, 2008

(54) MUSIC NOTATION SYSTEM AND METHOD

(76) Inventor: Andrew Joseph Weitz, Studio City, CA (US)

Correspondence Address: MARC E. HANKIN, ESQ., 11414 THURSTON CIRCLE, LOS ANGELES, CA, 90049, US

(21) Appl. No.: 11/612,430

(22) Filed: Dec. 18, 2006

(51) Int. Cl. G09B 15/00

(52) U.S. Cl. 84/483.1

(57) ABSTRACT

Various embodiments of this invention relate to improved systems for music notation. The systems for music notation improve upon conventional systems by eliminating the common symbols for notes and pitches and replacing them with an easily learnable system. By use of this system, a pedagogical system for music is also disclosed that further improves upon the conventional systems known in the art.

### FIELD OF INVENTION

Various embodiments of this invention relate, generally, to systems and methods for music notation; more particularly, to systems and methods for music notation that improve upon the conventional system for music notation and, thereby, aid in music pedagogy.

### BACKGROUND

Music notation, in varying forms, has existed for several millennia. There is evidence of a type of music notation used by the Egyptians from the Third Millennium BCE. Also, India's long history of sophisticated musical notation is demonstrated by musical treatises that have appeared throughout Indian history, going back to the Vedas composed from around 1500 BCE through around 500 BCE.

The current common system for music notation is attributed to Guido d'Arezzo, an Italian Benedictine monk who lived from 995-1050 CE. His revolutionary method, combining a 4-line stave with the first form of notes, paved the way to the five-line stave, which was introduced in the 14th century. Guido d'Arezzo's achievements paved the way for the modern form of written music, music books and the modern concept of a composer.

Today's western standard system for music notation uses one or more staves and written symbols in order to designate the playing notes on the instrument. Pitch is represented vertically on the staff, with higher pitches placed higher on the staff on or in between staff lines. Time, meanwhile, is represented horizontally on the musical staff, with left-to-right representing the passage of time.

A staff typically features a clef that indicates the particular range of pitches encompassed by the staff. Time signatures are placed at the beginning of staves in order to designate measures, which are sections of the piece of equal duration (with measure lines). A time signature of 4/4, for example, specifies that each measure will have four quarter notes worth of time per measure, the top numeral functioning as a cardinal number and the bottom numeral functioning as a code for quarter note. Key signatures are also placed at the beginning of a staff and serve to designate the key of the piece by specifying certain notes to be held flat or sharp throughout the piece, unless otherwise indicated.

Then, throughout the musical staff, appear the notes that are played by the instrumentalist. The notes' location on the staff (relative to a given line or lines) indicates the notes' pitch. The shape of the note and its flag indicate the length of the note and duration between two notes. Chords, or multiple notes played at the same time, are designated by notes placed vertically over one another. Also, special symbols are provided for rests of various lengths.

In this manner, the Western System of musical notation has been generally successful in allowing music composers and publishers to distribute musical works. Teachers of music, however, have struggled with the difficulty of teaching the Western System to music students. They have developed several cumbersome mnemonic devices, in order to assist students to learn the pitches on the staff. Unfortunately, these methods are oftentimes difficult to learn, and often are simply ineffective. Also, the difficulty of deciphering musical notation is often an added frustration to the already difficult task of learning to play music on a musical instrument. To the novice music student, the complex system of clefs, key signatures, and notes can appear as daunting as learning hieroglyphics, and that often detracts from the student's enthusiasm for taking up an instrument in the first place. Such complexity also detracts from the simple joy of playing music that is pleasing to the ear.

For these, and other reasons, numerous alternative systems for musical notation have been developed. U.S. Pat. No. 1,383 to Harrison, for example, discloses a system for musical notation comprising the placement of the first seven numerals over and under a simplified staff in order to designate the playing of musical notes. U.S. Pat. No. 6,528 to Heeringen, like several other U.S. Patents, discloses a system for musical notation wherein notes of different shapes (unlike the oval used in conventional notation) are used to designate different information. In Heeringen's patent, for example, the different shapes eliminate the use of the words “sharp” and “flat” entirely. Similarly, U.S. Pat. Nos. 482,442; 1,200,367; 1,480,380; and 6,124,540 to Robberson, Kinney, Reeve, and Lotito, respectively, teach systems for musical notation wherein varying shapes of note-heads are used to convey differing musical signals.

The system of musical notation disclosed by U.S. Pat. No. 391,887 to Fallon uses letters to notate melodies. Consonants are used to designate pitch, while vowels are used to designate duration. In this manner, the placement of consonants and vowels together can be used to notate a melody. Another novel system is disclosed by U.S. Pat. No. 1,473,495 to Miller, which discloses a musical notation system featuring the illustration of a piano keyboard such that the location of a note on the musical staff corresponds with a location on the illustrated keyboard.

A graphical system for musical notation is disclosed by U.S. Pat. No. 3,698,277 to Barra. Barra discloses a musical notation system wherein the notes are represented by rectangles, whose length indicates the length for which the notes are held when played. U.S. Pat. Nos. 6,127,616; 6,831,219; and 6,987,220; to Yu, Bonham, and Varme, respectively, and U.S. patent application Nos. 2004/0,007,118 and 2004/0,139,843 to Holcombe and Forster, respectively, all disclose systems for using colors in musical notation in order to designate various musical commands. U.S. Pat. No. 6,288,316 to Fajardo discloses a system for using new letters, “H, I, J, K, and L,” in order to replace the use of “sharp” and “flat” in musical notation.

While all of these patents represent variations on the conventional musical notation system that are directed towards improving and simplifying musical notation, none has successfully disclosed a functioning music notation system that has substantially improved upon the current conventional system, while simultaneously greatly simplifying music pedagogy. In order to address this and other issues, there remains a long felt need in the art for a simplified music notation system that greatly simplifies music pedagogy such that novice students may quickly and easily begin reading music.

### SUMMARY OF THE INVENTION

Various embodiments of this invention are directed towards overcoming the above shortcomings by disclosing a music notation system that greatly simplifies music pedagogy such that novice music students may quickly and easily learn to read and play music. Unlike the related-art systems discussed above, which alter the conventional music staff system in varying degrees, various embodiments of this invention serve to replace most of the notation devices found in conventional music notation.

First, various embodiments of this invention eliminate the common system of musical staves. The common “treble clef” and “bass clef” staves are replaced by a right-hand line, designated “RH” and a left-hand line, designated “LH”, which is typically directly below RH.

Second, various embodiments of this invention replace the common system of designating pitches. Rather than designate pitches on a staff, pitches are notated by writing out the name of the note. For example, the method uses “middle-C” as “home base.” B-flat is written as “B[flat-symbol].” Traditional symbols for sharps and flats, the angled numbered sign and angled lowercased “b” are still used in the method of this invention. Then, in order to designate where the correct note is found on the keyboard, symbols are used in the form of a number and the letter “A” or “B” (standing for “above” or “below”) such as: “1A,” “2A,” “3A,” 4A,” “1B,” “2B,” “3B,” “4B,” etc. The note designator “F_{2B}” indicates the second “F” below middle-C. “D#_{1A},” for example means the first “D#” note above middle C. Thus, through these notation symbols, any note on the scale of any instrument may be identified and played.

Third, various embodiments of this invention replace the conventional system for designating rests with various symbols. Instead, in various embodiments of this invention, a simple dash tells the student not to play.

Chords are designated in various embodiments of this invention through the use of circles and ovals that encircle the notes that comprise the chord. For example, in order to designate a C-major chord to be played, the letters “C,” “E,” and “G” are placed within a single oval. Meanwhile, in order to designate a chord that is played by both hands, a circle surrounds the notes on each of the lines and a connecting line is drawn between the two ovals. Other closed polygons such as squares, rectangles, triangles, ellipses, and other such shapes may also be used. For convenience, if a note is to be played along with the same note in another octave, the letters “OCT,” are placed next to the note. In this easy manner, the player is instructed to play both the note and the next higher similar note, one octave up.

Fingerings are designated in various embodiments of this invention by the same manner found in conventional musical notation. That is, as with the traditional methods, the thumbs are numbered “1” and the other fingers are ascending numbers outward through the pinky, which is “5.” These numbers appear adjacent to some of the note designations in order to instruct the student as to with which finger a particular note is to be played.

Various embodiments of this invention also deviate from the conventional system for designating note lengths, measures, and time. Measures are sectioned by using the vertical line as in the same manner of conventional music notation. The measures pass through the RH and LH lines, however, instead of passing through treble and bass clefs. An “up-arrow” or “down-arrow” is used to designate when to play one note and then go directly up to the next note or down to the preceding note and play that second note. Also, notes that are to be held for a period longer than a measure can be tied to a letter using a “tie,” as in the conventional notation method. In reference to the traditional method of time-signature, e.g., whole notes, quarter notes, eighth notes, sixteenth notes, thirty-second notes, etc., the notation method of this invention utilizes ear-training as a substitute for the traditional time-signature style. As an example, the student would correctly repeat a melodic phrase until the correct rhythm of the phrase is memorized through repetitive listening.

These and other innovations of the method allow novice music students to quickly and easily learn to play music on an instrument. In this manner, in a few short lessons, rather than learning mnemonic devices, a student can actually start playing songs. This is a vast improvement over the conventional method, and has the effect of encouraging students to continue playing music from very early in their experience, as compared with the traditional methods during which many students get frustrated and lose interest because of how difficult it is normally to learn enough music notation to play an actual song. Thus, this improved notation method is also an effective pedagogical tool because it keeps students excited about and interested in learning music.

While further details of this invention are omitted for the purposes of clarity, they remain known within the art and can be used with various embodiments of this invention. Also, it further remains within the contemplation of this invention to be adapted for use with all of the various instruments, including but not limited to, the woodwinds: flutes, piccolos, oboes, clarinets, bass clarinets, bassoons, contrabassoons; the brass: horns, trumpets, trombones, bass trombones, tubas; the strings: harps, violins, violas, cellos, double basses, classical guitars; the percussion: tympanis, snare drums, bass drums, celestas, marimbas, bass marimbas, xylophones, chimes, etc., and, of course, pianos. This invention may also be adapted for use with modern electronic instruments such as: electric guitars, bass guitars, electric drums, electric keyboards, and other such instruments.

### BRIEF DESCRIPTION OF THE DRAWINGS

FIG. 1 is an illustration of a traditional musical notation for a section of the musical piece “Liebestraum” by Franz Liszt, and is prior art.

FIG. 2 is an illustration of a section of the musical piece “Liebestraum” by Franz Liszt in the music notation system of the present invention.

FIG. 3 is an illustration of a traditional musical notation for a section of the song “Somewhere Over the Rainbow” by E. Y. Harburg and Harold Arlen, and is prior art.

FIG. 4 is an illustration of a section of the song “Somewhere Over the Rainbow” by E. Y. Harburg and Harold Arlen in the music notation system of the present invention.

FIG. 5 is an illustration of a traditional musical notation for a section of the musical piece “Prelude” by Johann Sebastian Bach, and is prior art.

FIG. 6 is an illustration of a section of the musical piece “Prelude” by Johann Sebastian Bach in the music notation system of the present invention.

### DETAILED DESCRIPTION OF THE DRAWINGS

In the following detailed description of one embodiment of this invention, numerous specific details are set forth in order to provide a thorough understanding of various aspects of one or more embodiments of this invention. One or more embodiments of this invention may be practiced without these specific details. In other instances, well-known methods, procedures, and/or components have not been described in detail so as not to unnecessarily obscure aspects of embodiments of this invention.

While one particular embodiment is disclosed, still other embodiments of the present invention will become apparent to those skilled in the art from the following detailed description, which shows and describes illustrative embodiments of this invention. As will be realized, this invention is capable of modifications in various obvious aspects, all without departing from the spirit and scope of the present invention. Accordingly, the drawings and detailed description are to be regarded as illustrative in nature and not restrictive. Also, the reference or non-reference to a particular embodiment of this invention shall not be interpreted to limit the scope of this invention. Various embodiments of this invention remain useable in tandem or combination with one another.

In the following description, certain terminology is used to describe certain features of one or more embodiments of this invention. For instance, “music[al] notation” refers to any of a number of systems of writing music for musical instruments known in the art and “music[al] instrument” refers to any of the various musical instruments known in the art including but not limited to: the woodwinds: flutes, piccolos, oboes, clarinets, bass clarinets, bassoons, contrabassoons; the brass: horns, trumpets, trombones, bass trombones, tubas; the strings: harps, violins, violas, cellos, double basses, classical guitars; the percussion: tympanis, snare drums, bass drums, celestas, marimbas, bass marimbas, xylophones, chimes, etc., and, of course, pianos. This invention may also be adapted for use with modern electronic instruments such as: electric guitars, bass guitars, electric drums, electric keyboards, and other such instruments.

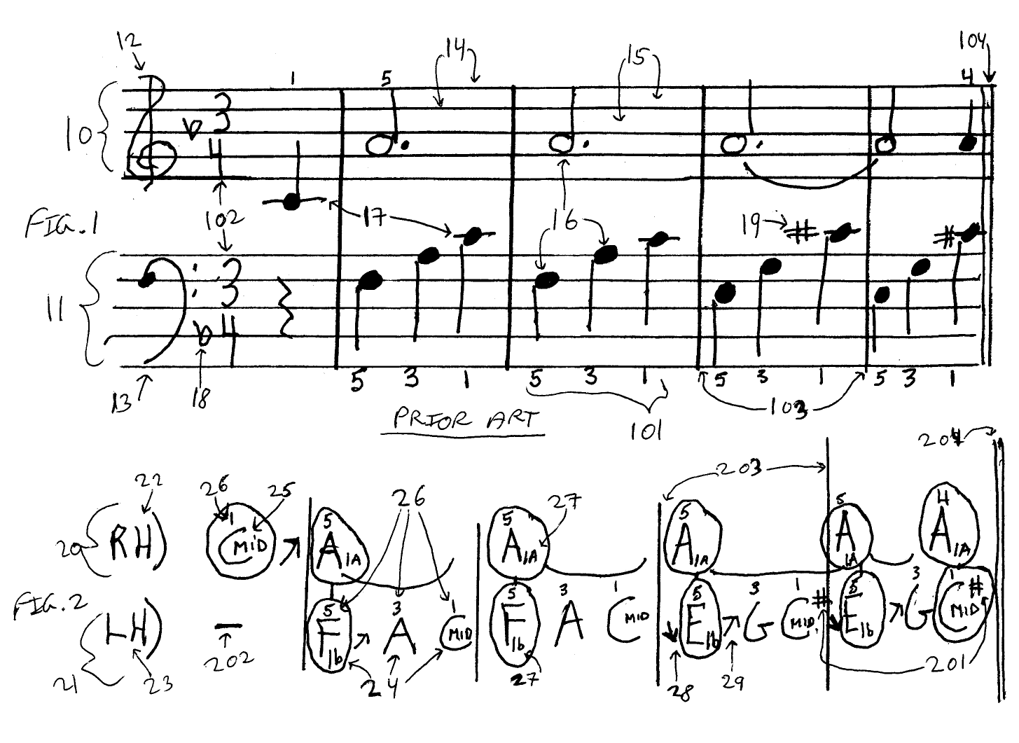

FIG. 1 is an illustration of a traditional musical notation for a section of the musical piece “Liebestraum” by Franz Liszt, and is prior art. The traditional, prior art, music notation shows a top staff 10 consisting of a grid of horizontal lines 14 separated by spaces 15 that tells the right hand what to play and a bottom staff 11 that tells the left hand what to play. The top staff is marked with a treble clef 12 and the bottom staff with a bass clef 13. On the staff, there are notes 16 and above or below the staff, other notes are indicated on ledger lines 17. Flats are indicated by a flat symbol “b” 18 and sharps are indicated by a sharp symbol (“#”) 19. Sometimes, notations are used to indicate which fingers of the hand are to be used to play certain notes 101. Time signatures 102 are placed at the beginning of the staves in order to designate measures, which are sections of the piece of equal duration, indicated by measure lines 103 also known as bar lines. The end of the piece is designated with a double bar line 104, often with the second bar line thicker than the first.

FIG. 2 is an illustration of a section of the musical piece “Liebestraum” by Franz Liszt in the music notation system of the present invention. As with the traditional music notation, there is still a top staff 20 and a bottom staff 21. Rather than use a particular clef, however, the top staff is indicated with the letters “RH” 22 to indicate the “Right Hand” and the bottom staff is indicated with the letters “LH” 23 to indicate the “Left Hand”. Rather than using note signs on or between horizontal lines, the actual letters of the notes 24 are used. If the note were to be “middle-C” then it would be indicated as C mid 25 and the correct finger to use to play that note is indicated using a number above the note, from 1 to 5, for the specific finger 26. A note designator 27 is used to indicate which specific note should be played, relative to middle-C; for example, the first F note below middle-C or the first A note above middle-C, as indicated in FIG. 2. A down-arrow 28 or an up-arrow 29 are used to indicate that one should play the note indicated at the start of the arrow and the note indicated at the point of the arrow, either the note before or after the starting note. Sharps are still indicated by use of a sharp symbol 201. A rest is indicated by use of a dash 202. Measure lines 203 or bar lines still are used to assist with keeping time, and a double bar line 204 is still used at the end of a section or the final end of a piece of music.

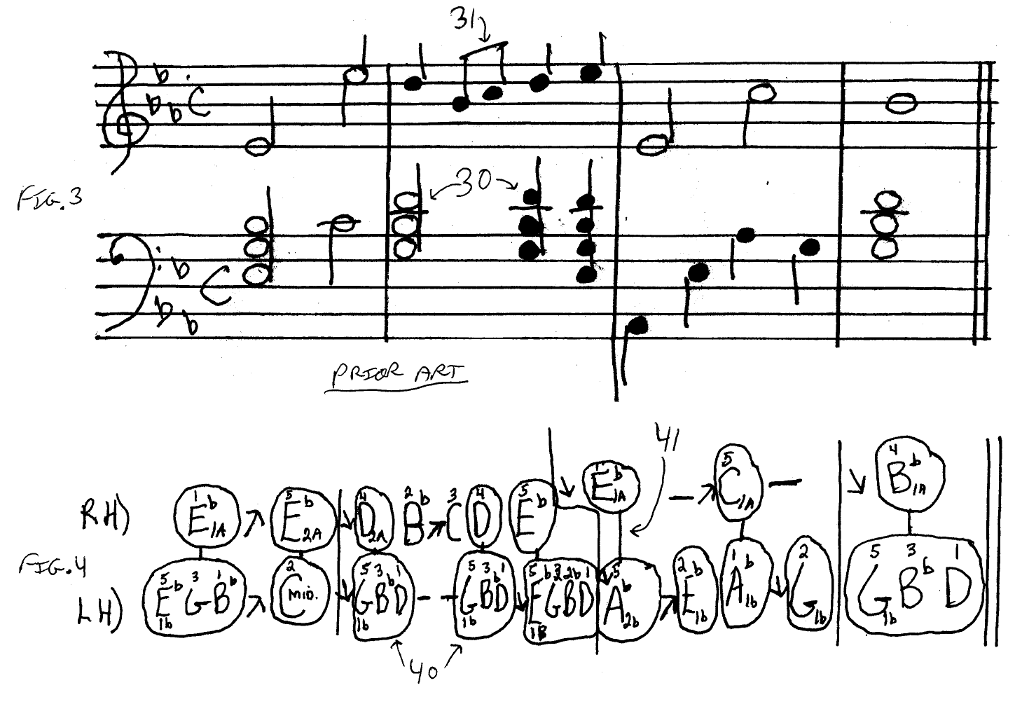

FIG. 3 is an illustration of a traditional musical notation for a section of the song “Somewhere Over the Rainbow” by E. Y. Harburg and Harold Arlen, and is prior art. Chords, or multiple notes played at the same time, are designated by notes placed vertically over one another 30. Notes that lie together in groups may be designated by connecting them with a line known as a beam 31. The number of beams, or connections, indicates the type of the note; for example, one connected line indicates an eighth note, two connected lines indicate a sixteenth note, and three connected lines indicate a thirty-second note.

FIG. 4 is an illustration of a section of the song “Somewhere Over the Rainbow” by E. Y. Harburg and Harold Arlen in the music notation system of the present invention. Chords, or multiple notes played at the same time, are designated by notes placed within circles or ovals 40. Chords that consist of notes that are played by both hands are designated by placing a circle around the notes of the chord on each of the lines and then placing a connecting line 41 between the two ovals.

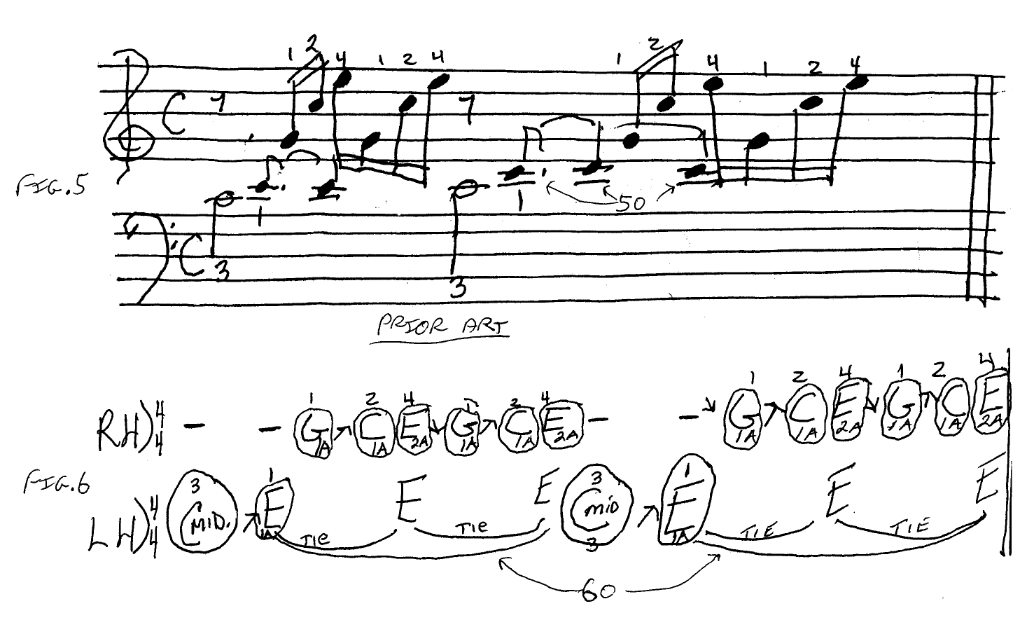

FIG. 5 is an illustration of a traditional musical notation for a section of the musical piece “Prelude” by Johann Sebastian Bach, and is prior art. With a more complicated piece of music, it is necessary to use more ledger lines 50.

FIG. 6 is an illustration of a section of the musical piece “Prelude” by Johann Sebastian Bach in the music notation system of the present invention. When the duration of a note may not be easily notated or if the duration of a note is long, groups of notes can be linked together by one or more ties 60. Tied notes are treated as a single unbroken note whose duration is given by the duration of the notes under the tie taken successively.

1. A music notation system, comprising:
designating notes to be played by the instrumentalist by writing the letter name commonly associated with the note along with an octave designation for the note,
said octave designation designating which octave said note is played in and comprising a two-digit code wherein a first digit comprises a number, said number corresponding to number of octaves above or below middle-C where the note is found, and second digit comprises a letter, said letter designating whether said note is played above or below middle-C, and
designating notes being played in succession by an arrow system wherein an up-arrow between two note designations indicates that one or more notes found above the first note designation and below the second note designation are to be played in succession to one another and a down-arrow between two note designations indicates that one or more notes found below the first note designation and above the second note designation are to be played in succession to one another.

2. The music notation system according to claim 1, wherein said letter corresponds to the letter “A” to designate that said note is above middle-C and said letter corresponds to “B” to designate that said note is below middle-C.

3. The music notation system according to claim 1, wherein said music notation system is used to notate music for a musical instrument played with two hands and includes two parallel horizontal staves, a first of said two parallel horizontal staves being used to notate notes played by the right hand and a second of said two parallel horizontal staves being used to notate notes played by the left hand.

4. (canceled)

5. The music notation system according to claim 1, which further comprises a system for designating rests with a dash.

6. The music notation system according to claim 1, wherein the act of playing more than one note at a time is symbolized by encircling the more than one note with a circle or an oval.

7. The music notation system according to claim 1, wherein the act of playing more than one note at a time by two different hands is symbolized by encircling the note or notes played by each hand with a circles or ovals and connecting the circles or ovals of each hand to one another by a horizontal line.

8. The music notation system according to claim 1, wherein numbers located adjacent to the note designation are used to designate which finger a note is played with.

9. The music notation system according to claim 1, wherein said system is further used for music pedagogy purposes.

10. A music notation system, comprising:
designating notes to be played by the instrumentalist by writing the letter name commonly associated with the note along with an octave designation for the note,
said octave designation designating which octave said note is played in and comprising a two-digit code wherein a first digit comprises a number, said number corresponding to number of octaves above or below middle-C where the note is found, and second digit comprises a letter, said letter being “A” to designate above middle-C and “B” to designate below middle-C,
designating notes being played in succession by an arrow system wherein an up-arrow between two note designations indicates that one or more notes found above the first note designation and below the second note designation are to be played in succession to one another and a down-arrow between two note designations indicates that one or more notes found below the first note designation and above the second note designation are to be played in succession to one another,
notating music for a musical instrument played with two hands and including two parallel horizontal staves, a first of said two parallel horizontal staves being used to notate notes played by the right hand and a second of said two parallel horizontal staves being used to notate notes played by the left hand,
designating rests with a dash,
designating the act of playing more than one note at a time by encircling the more than one note with a circle or an oval,
designating the act of playing more than one note at a time by two different hands by encircling the note or notes played by each hand with a circles or ovals and connecting the circles or ovals of each hand to one another by a horizontal line, and
designating the finger with which a note is to be played by numbers located adjacent to the note designation wherein said numbers are used in the following manner: “1” to indicate the thumb, “2” to indicate the index finger, “3” to indicate the middle finger, “4” to indicate the ring finger, and “5” to indicate the Dinky.

11. The music notation system according to claim 10, wherein said music notation system is used to notate music for one or more of the instruments selected from the following: flute, piccolo, oboe, clarinets, bass clarinet, bassoon, contrabassoon, horn, trumpet, trombone, bass trombone, tuba, timpani, snare drum, bass drum, celesta, marimba, bass marimba, xylophone, chimes, harp, violin, viola, cello, double bass, classical guitar, electric guitar, bass guitar, electric drums, electric keyboards, and piano.

12. The music notation system according to claim 11, wherein said system and method is further used for music pedagogy purposes.

13. A music pedagogy system, comprising:
designating notes to be played by the instrumentalist by writing the letter name commonly associated with the note along with an octave designation for the note,
said octave designation designating which octave said note is played in and comprising a two-digit code wherein a first digit comprises a number, said number corresponding to number of octaves above or below middle-C where the note is found, and second digit comprises a letter, said letter being “A” to designate above middle-C and “B” to designate below middle-C,
designating notes being played in succession by an arrow system wherein an up-arrow between two note designations indicates that one or more notes found above the first note designation and below the second note designation are to be played in succession to one another and a down-arrow between two note designations indicates that one or more notes found below the first note designation and above the second note designation are to be played in succession to one another,
notating music for a musical instrument played with two hands and including two parallel horizontal staves, a first of said two parallel horizontal staves being used to notate notes played by the right hand and a second of said two parallel horizontal staves being used to notate notes played by the left hand,
designating rests with a dash,
designating the act of playing more than one note at a time by encircling the more than one note with a circle or an oval,
designating the act of playing more than one note at a time by two different hands by encircling the note or notes played by each hand with a circles or ovals and connecting the circles or ovals of each hand to one another by a horizontal line, and
designating the finger with which a note is to be played by numbers located adjacent to the note designation wherein said numbers are used in the following manner: “1” to indicate the thumb, “2” to indicate the index finger, “3” to indicate the middle finger, “4” to indicate the ring finger, and “5” to indicate the Dinky.

14. The music pedagogy system according to claim 13, wherein said music notation system is used to notate music for one or more of the instruments selected from the following: flute, piccolo, oboe, clarinets, bass clarinet, bassoon, contrabassoon, horn, trumpet, trombone, bass trombone, tuba, timpani, snare drum, bass drum, celesta, marimba, bass marimba, xylophone, chimes, harp, violin, viola, cello, double bass, classical guitar, electric guitar, bass guitar, electric drums, electric keyboards, and piano.

15. (canceled)
